(19) United States
(12) Patent Application Publication
(10) Pub. No.: US 2024/0338442 A1
(43) Pub. Date: Oct. 10, 2024

(54) CLIENT-SIDE COMPOSITION ANALYSIS

(71) Applicant: MICRO FOCUS LLC, SANTA CLARA, CA (US)

(72) Inventors: Shawn Morgan Simpson, Alpharetta, GA (US); Vladyslav Voloshyn, Cumming, GA (US); Eyal Jakob, Cumming, GA (US)

(73) Assignee: MICRO FOCUS LLC, SANTA CLARA, CA (US)

(21) Appl. No.: 18/131,041

(22) Filed: Apr. 5, 2023

(51) Int. Cl. G06F 21/56; G06F 21/55; G06F 21/57

(52) U.S. Cl. CPC G06F 21/563; G06F 21/554; G06F 21/577; G06F 2221/033

(57) ABSTRACT

Software developers and security personnel routinely scan code to look for threats, such as security vulnerabilities. While such scans are useful, they are unable to determine the actual data provided to a client device executing a web application. By monitoring the web traffic to a client, the libraries utilized by the web application may be determined by name, version, and vendor. With the library identified, the libraries may be provided to one or more repositories of vulnerabilities to identify the particular vulnerabilities of the library. With the vulnerability identified, a resolution (e.g., version wherein the vulnerability was fixed) may be identified and/or other action to mitigate the vulnerability.

### FIELD OF THE DISCLOSURE

The invention relates generally to systems and methods for detecting software vulnerabilities and particularly to determining, from the web traffic delivered to a client, the libraries utilized by a web application and the vulnerabilities therein.

### BACKGROUND

Businesses and other software developers need to secure their software. Using third-party and open-source components can greatly reduce the time and effort to implement features into a software application; however, such components may introduce threats or vulnerabilities into the application. Other techniques are readily available for detecting and validating software components on servers that are used during the development process. However, the software known to a server and utilized to develop a client application may differ from the software actually executing on the client.

### SUMMARY

These and other needs are addressed by the various embodiments and configurations of the present invention. The present invention can provide a number of advantages depending on the particular configuration. These and other advantages will be apparent from the disclosure of the invention(s) contained herein.

In one embodiment, software composition analysis is disclosed on the client-side code. The code scanned and tested on the server and during development may not be the same code that makes its way from the server down to the client when an application is running. Rather than what a server-side analysis of client software expects a client to load and execute, the software composition analysis can notify security testers and developers of what is actually making it down to the client, including the vulnerabilities of those components.

Exemplary aspects are directed to:
A method for determining a client-side threat, comprising: monitoring web traffic to a client device; identifying, from the web traffic, a code library utilized by the client device; determining, from the code library, a code library name and a code library version of the code library; providing a database of known code library vulnerabilities with the code library name and code library version number and, in response, receiving a list of known vulnerabilities; and determining that the list of known vulnerabilities comprises at least one actionable vulnerability and activating a mitigation process to attenuate the at least one actionable vulnerability.
A system for determining a client-side threat, comprising: a network interface to a network; and a processor coupled to a computer memory having instructions therein to cause the processor to perform: monitoring web traffic received via the network to a client device; identifying, from the web traffic, a code library utilized by the client device; determining, from the code library, a code library name and a code library version of the code library; providing a database of known code library vulnerabilities with the code library name and code library version number and, in response, receiving a list of known vulnerabilities; and determining that the list of known vulnerabilities comprises at least one actionable vulnerability and activating a mitigation process to attenuate the at least one actionable vulnerability.
A system for determining a client-side threat, comprising: mean to monitor web traffic received via the network to a client device; means to identify, from the web traffic, a code library utilized by the client device; means to determine, from the code library, a code library name and a code library version of the code library; means to provide a database of known code library vulnerabilities with the code library name and code library version number and, in response, receiving a list of known vulnerabilities; and means to determine that the list of known vulnerabilities comprises at least one actionable vulnerability and activating a mitigation process to attenuate the at least one actionable vulnerability.
Any of the above aspects:
Wherein the web traffic is monitored by a monitoring device discrete from the client device.
Wherein: receiving the list of known vulnerabilities further comprises receiving a replacement code library, wherein the replacement code library comprises the code library name and a replacement code library version absent the at least one actionable vulnerability; and activating the mitigation process comprises downloading the replacement code library.
Wherein the code library comprises at least one of a JavaScript code library and an open-source code library.
Wherein the database of known code library vulnerabilities comprises at least one of a National Vulnerability Database (NVD) operated by the National Institute of Standards and Technology (NIST), a Micro Focus Debricked Common Vulnerabilities and Exposures (CVE) database, and a GitHub Security Advisory Database (GHSA) database.
Wherein determining, from the code library, the code library name and the code library version of the code library comprises inspecting a Document Object Model (DOM) corresponding to the code library.
Wherein inspecting the DOM further comprises intercepting a DOM hook utilized by the code library.
Wherein determining the code library from the web traffic further comprises identifying an attribute of at least a portion of the web traffic known to be associated with the code library.

A system on a chip (SoC) including any one or more of the above aspects of the embodiments described herein.

One or more means for performing any one or more of the above aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112 (f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a process flow in accordance with embodiments of the present disclosure;

FIG. 3 depicts a report in accordance with embodiments of the present disclosure; and

FIG. 4 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

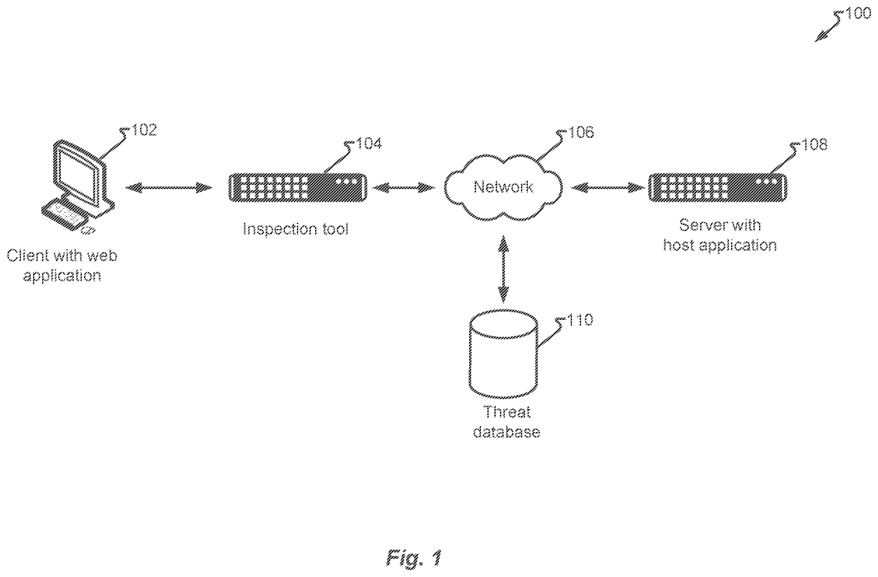

FIG. 1 depicts system 100 in accordance with embodiments of the present disclosure. In one embodiment, system 100 determines what software libraries are actually being requested when client 102 executes a client portion of an application in conjunction with server 108 executing a server portion of the application. In one embodiment, client 102 requests data, which may comprise executable code or other content that may be executed by client 102 that may have a vulnerability. Generally, software is embodied as a library, often open-source code, or other third-party code. The software may pose a threat in terms of malware or a vulnerability that may allow the security of client 102, data, or other portion of a network to be compromised.

In one embodiment, client 102 executes a client-side application which calls one or more libraries or other portions of software code to be downloaded via network 106. In response, inspection tool 104 monitors the traffic to client 102 and determines which libraries are being requested. Inspection tool 104 may comprise a stand-alone server or, in other embodiments, be embodied as a processing component co-embodied with client 102 or other computing component (e.g., router, switch, etc.) and/or a process on a shared processor of client 102.

The traffic determines, positively or within a subset of possibilities, the libraries being called by client 102 by name and version. Inspection tool 104 determines if the identified library, and the particular version, have any known threats from threat database 110. If a threat is found, a mitigating action is performed such as to trigger a warning on client 102, disable the software on client 102, block any remaining traffic to client 102, and/or from server 108, notify security personnel, etc. Additionally or alternatively, a particular library that is being called by client 102, which has an identified vulnerability, may be automatically rebuilt (e.g., recompiled, relinked, etc.) with an updated version of the library that is known to be absent the vulnerability. As a further option, threats may be minor (e.g., recoverable errors, non-intuitive operation, etc.), which may be identified as remedied in a particular version of a library. Fixing minor errors may be of little concern by themselves; however, if a subsequent version of the library (a version after the version that fixes a more serious threat) addresses the minor threat, then the subsequent version may be selected.

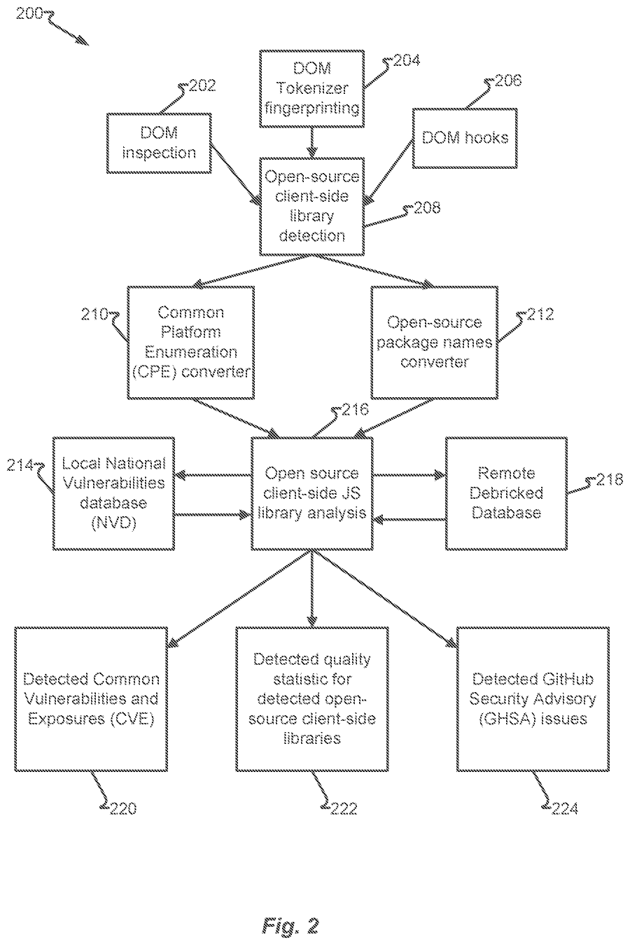

FIG. 2 depicts process flow 200 in accordance with embodiments of the present disclosure. In one embodiment, inspection tool 104 executes one or more operations of process flow 200. Generally, process flow 200 comprises a library detection portion, comprising operations 202, 204, 206, and 208, and an analysis portion. The analysis portion comprises operations 210-224, inclusively. The library detection process identifies the libraries being called by client 102 by name and version. With the name and version of the library known, the analysis portion determines the presence and degree of any threats that are present in the identified libraries and, optionally, remedies (e.g., the library version(s) that address the threat and/or alternative libraries).

A client application is launched, such as on client 102, and every portion of the application (e.g., all web pages, all graphical elements, etc.) is accessed or, if attempted and failed, noted accordingly. Operation 202 performs a Document Object Model (DOM) inspection to determine coding framework, such JQuery or AngularJS, and the version thereof. For example, operation 202 loads a web page with a window object and then inspects the data to determine what objects and methods are present within the window object. Operation 204 obtains sequences of DOM entities (see U.S. Patent 10,152,552 issued on Dec. 11, 2018, titled, “Analyzing a Structure of a Web Application to Produce Actionable Tokens,” which is incorporated herein by reference). Additionally or alternatively, operation 206 utilizes DOM to insert a software development emulation DOM hook, which may or may not be a true “hook,” and then utilizes the hook to intercept events. The output of operations 202, 204, and 206 are provided to operation 208 in order to detect which open-source client-side library(ies) is being utilized. Operation 208 may be utilized to identify JavaScript or other libraries. In one example, knowing the data structure, order, format, type, graphical elements, and other forms of DOM objects (from operations 202, 204, and 206) allows for all potential libraries, and versions thereof, to be narrowed down to a few and, generally, one that is utilized by a particular client-side application. Once the libraries are identified, process flow 200 determines whether there are vulnerabilities present. Identification of a library may include identifying the name of a library and may further include the version, vendor, and/or application level.

Operation 210 receives the name and version of the library identifiers and builds a database key, such as to convert the identifiers into a common platform enumeration (CPE). Operation 212 determines what package is identified or identified with a previously determined degree of certainty, such as a Node Package Manager (NPM) package of JavaScript packages.

The library identified are used as a key to access vulnerability databases and determine the vulnerabilities, if any, the library has. Accordingly, the identifier is provided to one or more repositories of vulnerabilities, such as operation 216 accessing the National Vulnerabilities Database (NVD) in operation 214 and/or a proprietary database such as Debricked™ database in operation 218. Alternative and additional databases may be accessed in other embodiments.

Next, the results of the vulnerabilities are processed and reported. Reporting may identify other vulnerabilities in a library that are known but do not apply to the particular client-side application being tested. Reporting may include identification of the library, vendor, version, contributors, popularity, security, severity of the vulnerabilities, version where the vulnerability started, version(s) that fixed the vulnerability, etc. Reporting may add records to one or more databases of vulnerabilities, including but not limited to detected Common Vulnerabilities and Exposures (CVE) in operation 220, detected quality statistics for the open-source client-side libraries in operation 222, and detected GitHub Security Advisory (GHSA) issues in operation 224. In other embodiments, other data sources, such as GitHub's own advisories (available at githob.com/advisories) are used instead of or in addition to any of the foregoing of vulnerabilities.

In another embodiment, the operations of data flow 200 are provided in a single, stand-alone application, such as one executing on server 108, or as a portion of other tools, such as WebInspect™ or other security monitoring device or application.

As a benefit of the embodiments provided herein, vulnerabilities in a run-time environment are determined by what a client application is actually receiving. As a result, man-in-the-middle attacks, content delivery network (CDN) poising, or other similar attacks that are undetectable in source code are identified and mitigated.

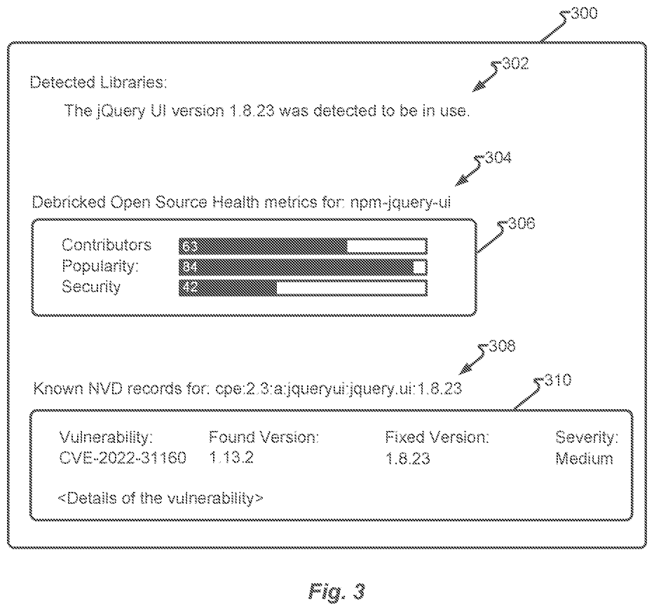

FIG. 3 depicts report 300 in accordance with embodiments of the present disclosure. Report 300 may be provided as the output from inspection tool 104 upon monitoring traffic to client 102. Report 300 may comprise text 302 providing the name and version of the library found. Record 304 identifies the library from one source (e.g., Debricked) and relative indicators 306 of the security and robustness of the library across a user community. Record 308 identifies the library, vendor, and version from a second source (e.g., the NVD). Block 310 identifies the specific vulnerability (which may comprise a hyperlink to a source), the version found, the version fixed, the severity, and a textual description. Block 310 may then repeat for each vulnerability in the library.

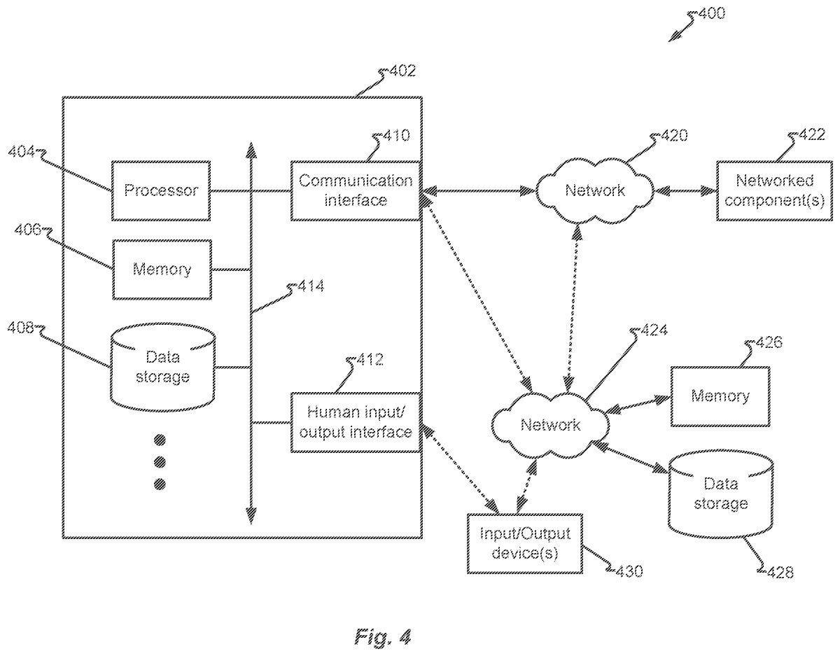

FIG. 4 depicts device 402 in system 400 in accordance with embodiments of the present disclosure. In one embodiment, client 102, inspection tool 104, and server 108 may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414. Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, speaker, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Network 106 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.).

Additionally or alternatively, one or more other networks may be utilized. For example, network 424 may represent a second network, which may facilitate communication with components utilized by device 402. For example, network 424 may be an internal network to a business entity or other organization, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter. What Is Claimed Is:

1. A method for determining a client-side threat, comprising:
monitoring web traffic to a client device;
identifying, from the web traffic, a code library utilized by the client device;
determining, from the code library, a code library name and a code library version of the code library;
providing a database of known code library vulnerabilities with the code library name and code library version number and, in response, receiving a list of known vulnerabilities; and
determining that the list of known vulnerabilities comprises at least one actionable vulnerability and activating a mitigation process to attenuate the at least one actionable vulnerability.

2. The method of claim 1, wherein the web traffic is monitored by a monitoring device discrete from the client device.

3 The method of claim 1, wherein:
receiving the list of known vulnerabilities further comprises receiving a replacement code library, wherein the replacement code library comprises the code library name and a replacement code library version absent the at least one actionable vulnerability; and
activating the mitigation process comprises downloading the replacement code library.

4. The method of claim 1, wherein the code library comprises at least one of a JavaScript code library and an open-source code library.

5. The method of claim 1, wherein the database of known code library vulnerabilities comprises at least one of a National Vulnerability Database (NVD) operated by the National Institute of Standards and Technology (NIST), a Micro Focus Debricked Common Vulnerabilities and Exposures (CVE) database, and a GitHub Security Advisory Database (GHSA) database.

6. The method of claim 1, wherein determining, from the code library, the code library name and the code library version of the code library comprises inspecting a Document Object Model (DOM) corresponding to the code library.

7. The method of claim 6, wherein inspecting the DOM further comprises intercepting a DOM hook utilized by the code library.

8. The method of claim 1, wherein determining the code library from the web traffic further comprises identifying an attribute of at least a portion of the web traffic known to be associated with the code library.

9. A system for determining a client-side threat, comprising:
a network interface to a network; and
a processor coupled to a computer memory having instructions therein to cause the processor to perform:
monitoring web traffic received via the network to a client device;
identifying, from the web traffic, a code library utilized by the client device;
determining, from the code library, a code library name and a code library version of the code library;
providing a database of known code library vulnerabilities with the code library name and code library version number and, in response, receiving a list of known vulnerabilities; and
determining that the list of known vulnerabilities comprises at least one actionable vulnerability and activating a mitigation process to attenuate the at least one actionable vulnerability.

10. The system of claim 9, wherein the processor is a device discrete from the client device.

11. The system of claim 9, wherein:
receiving the list of known vulnerabilities further comprises receiving a replacement code library, wherein the replacement code library comprises the code library name and a replacement code library version absent the at least one actionable vulnerability; and
activating the mitigation process comprises downloading the replacement code library.

12. The system of claim 9, wherein the code library comprises at least one of a JavaScript code library and an open-source code library.

13. The system of claim 9, wherein the database of known code library vulnerabilities comprises at least one of a National Vulnerability Database (NVD) operated by the National Institute of Standards and Technology (NIST), a Micro Focus Debricked Common Vulnerabilities and Exposures (CVE) database, and a GitHub Security Advisory Database (GHSA) database.

14. The system of claim 9, wherein determining, from the code library, the code library name and the code library version of the code library comprises inspecting a Document Object Model (DOM) corresponding to the code library.

15. The system of claim 14, wherein inspecting the DOM further comprises intercepting a DOM hook utilized by the code library.

16. The system of claim 9, wherein determining the code library from the web traffic further comprises identifying an attribute of at least a portion of the web traffic known to be associated with the code library.

17. A system for determining a client-side threat, comprising:
means to monitor web traffic received via a network to a client device;
means to identify, from the web traffic, a code library utilized by the client device;
means to determine, from the code library, a code library name and a code library version of the code library;
means to provide a database of known code library vulnerabilities with the code library name and code library version number and, in response, receiving a list of known vulnerabilities; and
means to determine that the list of known vulnerabilities comprises at least one actionable vulnerability and activating a mitigation process to attenuate the at least one actionable vulnerability.

18. The system of claim 17, wherein the code library comprises at least one of a JavaScript code library and an open-source code library.

19. The system of claim 17, wherein the database of known code library vulnerabilities comprises at least one of a National Vulnerability Database (NVD) operated by the National Institute of Standards and Technology (NIST), a Micro Focus Debricked Common Vulnerabilities and Exposures (CVE) database, and a GitHub Security Advisory Database (GHSA) database.

20. The system of claim 17, wherein determining, from the code library, the code library name and the code library version of the code library comprises inspecting a Document Object Model (DOM) hook utilized by the code library.
